(19) United States
(12) Patent Application Publication
(10) Pub. No.: US 2011/0060432 A1
(43) Pub. Date: Mar. 10, 2011

(54) METHOD FOR TESTING AUDIO FUNCTION OF COMPUTER

(75) Inventor: QING-HUA LIU, Shenzhen City (CN)

(73) Assignees: HONG FU JIN PRECISION INDUSTRY (ShenZhen) CO., LTD, Shenzhen City (TW); HON HAI PRECISION INDUSTRY CO., LTD., Tu-Cheng (TW)

(21) Appl. No.: 12/647,733

(22) Filed: Dec. 28, 2009

(30) Foreign Application Priority Data
Sep. 4, 2009 (CN) 200910306569.X

(51) Int. Cl. G06F 17/00

(52) U.S. Cl. 700/94

(57) ABSTRACT

In a method for testing computer audio function, a computer obtains and saves a sample audio file therein. An audio playback module of the computer plays the sample audio file. An audio record module of the computer records output audio signals during playback of the sample audio file. A recorded audio file is stored into the computer. A test module of the computer analyzes and compares waveforms of the recorded audio file and the sample audio file to determine whether the audio function of the computer is acceptable.

### BACKGROUND

1. Technical Field

The present disclosure relates to a method for testing computer audio function.

2. Description of Related Art

Normally, computers are tested before shipping to market for all necessary functions. One necessary test is for audio function. A conventional method for testing computer audio function includes playback of a sample audio file using a left audio channel and/or a right audio channel of the computer; wherein a tester determines, by listening to the output, whether the audio function of the computer is passable. While easily performed, results of the test are subjective and thus less than accurate.

What is needed, therefore, is a testing method for more accurately testing computer audio function.

### BRIEF DESCRIPTION OF THE DRAWINGS

FIG. 1 is a block diagram of a computer for audio testing.

FIGS. 2A-2B comprise a flowchart of a method for testing audio function of a computer, such as, for example, that of FIG. 1.

FIGS. 3A-3C illustrate different volume settings of a left audio channel and a right audio channel of the computer of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

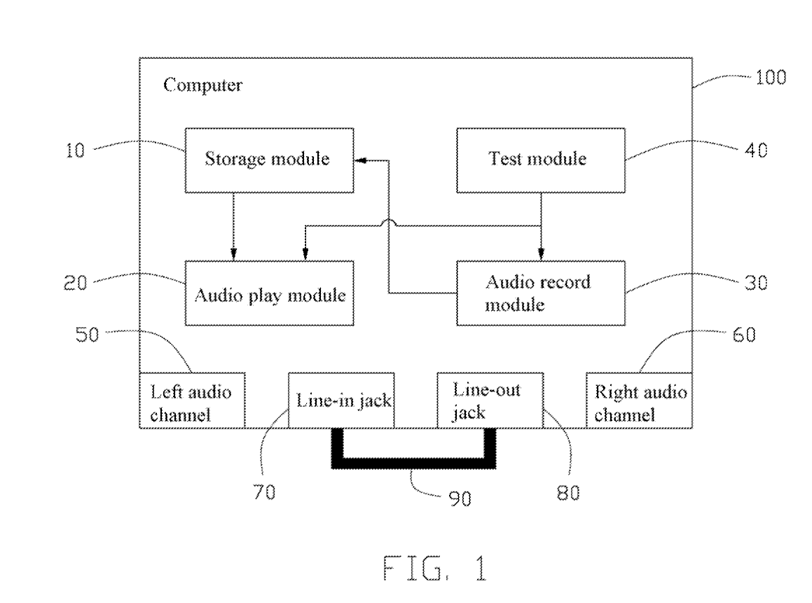

Referring to FIG. 1, a computer 100 includes a storage module 10, an audio playback module 20, an audio record module 30, a test module 40, a left audio channel 50, and a right audio channel 60. The computer 100 provides audio playback and recording functions.

The storage module 10 is configured to store sample audio files and recorded audio files therein. The audio playback module 20 is configured to play the sample audio files, and the audio record module 20 is configured to obtain recorded audio files during playback of the sample audio files. The test module 40 is installed in the computer 100 for automatically testing the audio function of the computer 100. The computer 100 can output single-channel audio signals using either the left audio channel 50 or the right audio channel 60 or output stereophonic sound using both.

The computer 100 further includes a line-in jack 70 and a line-out jack 80. An audio cable 90 can be connected between the line-in jack 70 and the line-out jack 80 for eliminating unwanted surrounding noise during audio recording.

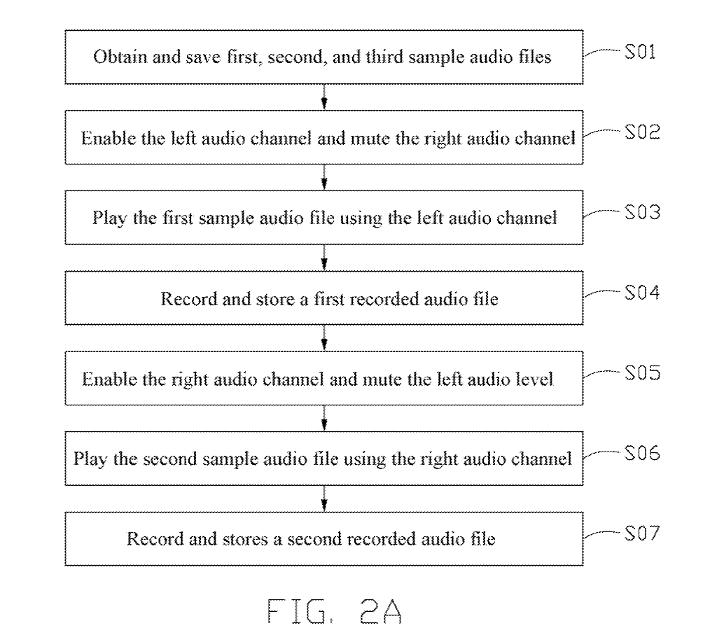

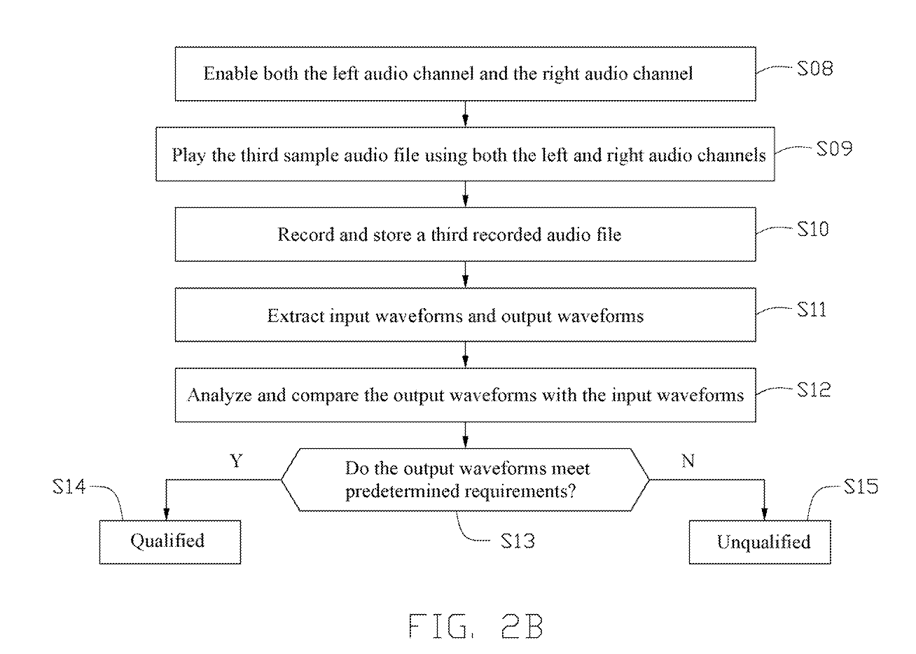

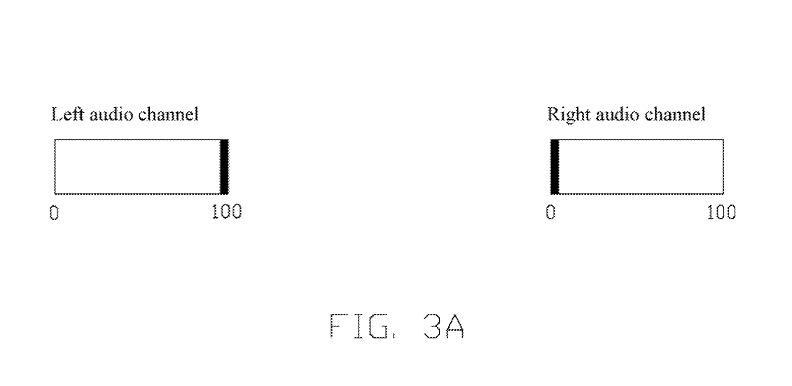

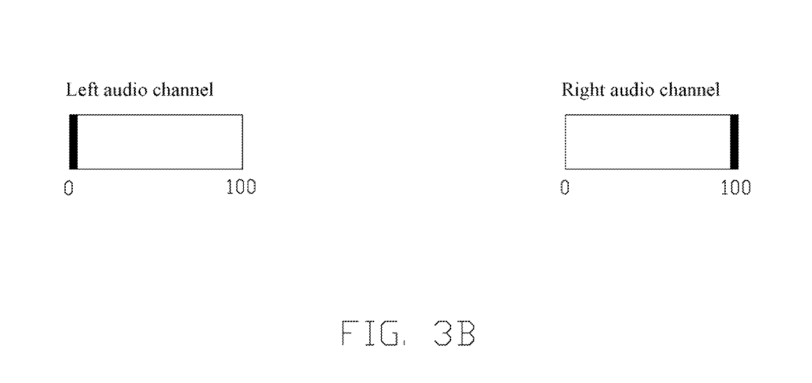

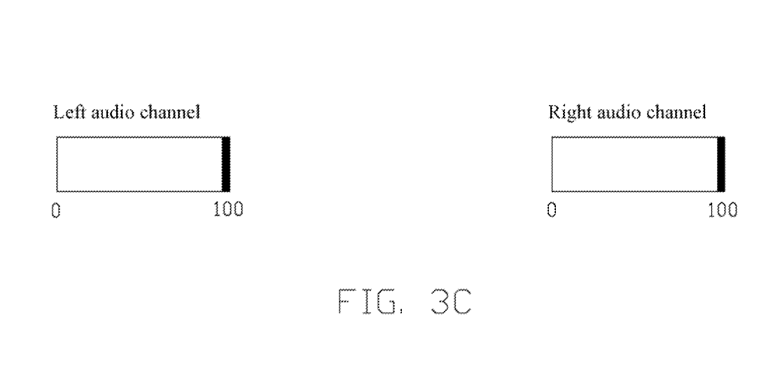

FIGS. 2A-2B and FIGS. 3A-3C, show an embodiment of a method for testing audio function of a computer 100, as follows.

In block S01, the computer 100 obtains and saves sample audio files in the storage module 10. The sample audio files include a first sample audio file, a second sample audio file, and a third sample audio file. Frequencies of waveforms of the sample audio files are different and distinguishable from each other.

In block S02, the test module 40 automatically sets a volume of the left audio channel 50 to a maximum value and sets a volume of the right audio channel 60 to a minimum value (See FIG. 3A). Thus, the left audio channel 50 is enabled while the right audio level 60 is muted, and the computer 100 can play back the sample audio files using the left audio channel 50.

In block S03, the audio playback module 20 of the computer 100 plays the first sample audio file using the left audio channel 50, while, simultaneously, a record function of the computer 100 is initiated.

In block S04, the audio record module 30 of the computer 100 records a first recorded audio file and stores the first recorded audio file into the storage module 10.

In block S05, the test module 40 automatically sets the volume of the left audio channel 50 to the minimum value and sets the volume of the right audio channel 60 to the maximum value (See FIG. 3B). Thus, the right audio channel 60 is enabled while the left audio level 50 is muted, and the computer 100 plays back the sample audio files using the right audio channel 60.

In block S06, the audio playback module 20 of the computer 100 plays back the second sample audio file using the right audio channel 60.

In block S07, the audio record module 30 of the computer 100 records a second recorded audio file and stores the second recorded audio file into the storage module 10.

In block S08, the test module 40 automatically sets the volume of both the left audio channel 50 and the right audio channel 60 to the maximum value (See FIG. 3B). Thus, both of the left audio channel 50 and the right audio channel 60 are enabled, and the computer 100 can play the sample audio files back using both channels.

In block S09, the audio playback module 20 of the computer 100 plays the third sample audio file using both the left audio channel 50 and the right audio channel 60 to generate stereophonic sound.

In block S10, the audio record module 30 of the computer 100 records a third recorded audio file and stores the third recorded audio file into the storage module 10.

In block S11, the test module 40 extracts waveforms of the sample audio files (input waveforms) and waveforms of the recorded audio files (output waveforms).

In block S12, the test module 40 analyzes and compares the output waveforms with the input waveforms. In this block, the test module 40 compares frequencies of each of the output waveforms with a related input waveform, calculates a degree of distortion for each of the output waveforms relative to the related input waveform, and calculates a signal-to-noise ratio of each of the output waveforms.

In block S13, the test module 40 determines whether the degree of distortion and the signal-to-noise ratio of each of the output waveforms meet predetermined requirements, and, if so, block S14 is implemented, otherwise, block S15 is implemented.

In block S14, a positive test result for audio function of the computer 100 is displayed.

In block S15, a negative test result for audio function of the computer 100 is displayed.

While the present disclosure has been illustrated by the description of preferred embodiments thereof, and while the preferred embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

Depending on the embodiment, certain of the steps of the methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A method for testing computer audio function for a computer comprising a left audio channel and a right audio channel, the method comprising:
saving a sample audio file to the computer;
playing the sample audio file;
recording output audio signals during playback of the sample audio file;
storing a recorded audio file; and
analyzing and comparing waveforms of the recorded audio file and the sample audio file to determine whether the audio function of the computer is acceptable.

2. The method of claim 1, further comprising enabling the left audio channel and muting the right audio channel before playing the sample audio file.

3. The method of claim 1, further comprising enabling the right audio channel and muting the left audio channel before playing the sample audio file.

4. The method of claim 1, further comprising enabling both the left audio channel and the right audio channel before playing the sample audio file.

5. The method of claim 1, further comprising reducing surrounding noise during audio recording.

6. The method of claim 1, further comprising extracting waveforms of the recorded audio file and the sample audio file before comparing waveforms of the recorded audio file and the sample audio file.

7. The method of claim 1, wherein comparison and analysis of waveforms of the recorded audio file and the sample audio file further comprise of comparing frequencies of the waveforms of the recorded audio file and the sample audio file, calculating a degree of distortion of the waveform of the recorded audio file, and calculating a signal-to-noise ratio of the recorded audio file.

8. The method of claim 7, further comprising outputting a test result indicating the audio function of the computer is acceptable if the degree of distortion and the signal-to-noise ratio both meet predetermined requirements or outputting a test result indicating the audio function of the computer is unacceptable if either or both of the degree of distortion and the signal-to-noise ratio fail to meet the predetermined requirements.

9. The method of claim 7, further comprising installing a test module on the computer.

10. A method for testing computer audio function, for a computer comprising a left audio channel and a right audio channel, the method comprising:
saving sample audio files to the computer;
playing each of the sample audio files in a related play mode;
recording audio signals during playback of each of the sample audio files;
storing recorded audio files corresponding to the sample audio files;
comparing waveforms of each of the recorded audio files and the corresponding sample audio file to determine whether the audio function of the computer is acceptable.

11. The method of claim 10, wherein the sample audio files comprise a first sample audio file, a second sample audio file, and a third sample audio file.

12. The method of claim 11, wherein playback of each of the sample audio files in the related play mode comprises of playing the first sample audio file using the left audio channel, playing the second sample audio file using the right audio channel, and playing the third sample audio channel using both the left audio channel and the right audio channel.

13. The method of claim 12, further comprising extracting waveforms of the recorded audio files and the sample audio files.

14. The method of claim 13, wherein the frequencies of the waveforms of the sample audio files are different.

15. The method of claim 10, wherein comparison and analysis of waveforms of each of the recorded audio file and the corresponding sample audio file further comprise of comparing frequencies of the waveforms of each the recorded audio file and the corresponding sample audio file, calculating a degree of distortion of the waveform of each the recorded audio file, and calculating a signal-to-noise ratio of the waveform of each of the recorded audio files.

16. The method of claim 15, further comprising outputting a test result indicating the audio function of the computer is acceptable, if the degree of distortion and the signal-to-noise ratio both meet predetermined requirements, or outputting a test result indicating the audio function of the computer is unacceptable, if either or both of the degree of distortion and the signal-to-noise ratio meet the predetermined requirements.
